(19) United States
(12) Patent Application Publication
(10) Pub. No.: US 2023/0401741 A1
(43) Pub. Date: Dec. 14, 2023

(54) METHOD, COMPUTER PROGRAM, AND APPARATUS FOR DETERMINING A RELATIVE POSITION OF A FIRST AERIAL VEHICLE AND AT LEAST ONE SECOND AERIAL VEHICLE TO EACH OTHER

(71) Applicant: Sony Group Corporation, Tokyo (JP)

(72) Inventor: Peter DÜRR, Stuttgart (DE)

(73) Assignee: Sony Group Corporation, Tokyo (JP)

(21) Appl. No.: 18/034,381

(22) PCT Filed: Nov. 4, 2021
(86) PCT No.: PCT/EP2021/080650

§ 371 Date: Apr. 28, 2023

(30) Foreign Application Priority Data
Nov. 5, 2020 (EP) 20206023.2

(51) Int. Cl. G06T 7/73; G01C 21/20

(52) U.S. Cl. CPC G06T 7/74; G01C 21/20; G06T 2207/30252

(57) ABSTRACT

The present disclosure relates to a method for determining a relative position of a first aerial vehicle and at least one second aerial vehicle to each other. The method comprises receiving first image data of a first camera system attached to the first aerial vehicle and second image data of a second camera system attached to the second aerial vehicle. Further, the method provides for determining the relative position using a geometric relation of the first and the second image data.

### FIELD

Embodiments of the present disclosure relate to a method, a computer program, and an apparatus for determining a relative position of a first aerial vehicle and at least one second aerial vehicle to each other.

### BACKGROUND

Due to an increasing number of aerial vehicles in the sky, concepts for avoiding collisions of aerial vehicles play an increasingly important role.

In order to avoid collisions, known concepts use satellite- or barometer-based positioning systems for navigating encountering aerial vehicles. Some applications may require a higher accuracy in locating encountering aerial vehicles than satellite- or barometer-based positioning systems can provide. In particular, the accuracy in vertical direction may be too low in satellite- and barometer-based positioning systems for some applications.

Hence, there may be a demand for improved concept for locating aerial vehicles.

### SUMMARY

This demand can be satisfied by the subject-matter of the appended independent and dependent claims.

According to a first aspect, the present disclosure relates to a method for determining a relative position of a first aerial vehicle and at least one second aerial vehicle to each other. The method comprises receiving first image data of a first camera system attached to the first aerial vehicle and second image data of a second camera system attached to the second aerial vehicle. Further, the method provides for determining the relative position using a geometric relation of the first and the second image data.

The first and the second camera system can be understood as a device for recording single or multiple images (e.g. a film). The first and the second camera system, for example, comprise a single camera, a stereo camera, or a multi-camera system/camera array including a (optical) photo camera or a film camera.

The first/the second aerial vehicle, for example, is an airplane, a helicopter, an unmanned aerial vehicle (UAV), or the like. The first and the second camera system can be attached below the first and the second aerial vehicle, respectively, and may record an environment below the respective first or second aerial vehicle.

The geometric relation, for example, is determined from similarities present in the first and the second image data. The geometric relation may indicate a relative location and/or an orientation of the first and the second camera system to each other and, thus, the relative position of the first and the second aerial vehicle.

The relative position particularly may be indicative of a relative altitude of the first and the second aerial vehicle to each other. Additionally, or alternatively, the relative position indicates a transversal/horizontal relative position of the first and the second aerial vehicle to each other.

For this reason, the method can be applied for positioning/locating the first and the second aerial vehicle and in some applications to avoid collisions of encountering aerial vehicles and to navigate aerial vehicles based on their relative position.

Depending on a spatial resolution of the first and the second camera system, the above method can provide a sub-m-accuracy in locating the first and the second aerial vehicle. The higher the spatial resolution, the higher may be the accuracy of the method. In particular, the accuracy can be higher than the accuracy of satellite- or barometer-based positioning systems/concepts.

It is noted that the above method is not limited to one first and one second aerial vehicle but can be applied for locating more than two aerial vehicles. It should be further noted that the first and the second aerial vehicle can be equipped with multiple cameras providing the first and/or the second image data. The first and the second image may include one or more images.

In some embodiments, determining the relative position comprises identifying a plurality of features present in both the first and the second image data using computer vision and determining first coordinates of the features in the first image data and second coordinates of the features in the second image data. For determining the geometric relation, the method can provide for using the first and the second coordinates.

The features, for example, relate to objects captured by both the first and the second camera system. The features may relate to static and particularly “unique”, “recognizable”, and/or “striking” objects within the environment of the aerial vehicles. For example, the objects are parts of buildings, plants, parking vehicles, infrastructure objects (e.g. streets), or the like.

The first and the second image data each may include a pixel array, wherein each pixel of the first and the second image data refers to coordinates of a respective (two-dimensional) coordinate system. Accordingly, the features in the image data relate to the first and the second coordinates in the (respective coordinate system of) the first and the second image data.

Those first and second coordinates, for example, are used as input to, for example, the so-called “(normalized) five-point algorithm” or “(normalized) eight-point algorithm” in computer vision for determining the geometric relation. In practice, the geometric relation includes the so-called “essential matrix” resulting from the five-point or eight-point algorithm.

The skilled person having benefit from the present disclosure will appreciate that the more features are used, the more accurate and reliable the geometric relation of the first and the second image data and the localization of the aerial vehicles can be.

In some embodiments, the method comprises synchronizing the first and the second camera system for synchronously recording the first and the second image data.

The first and the second camera system, for example, communicate via radio signals to synchronize with each other.

In some embodiments, at least one of the first and the second aerial vehicle is an unmanned aerial vehicle.

In some embodiments, the method provides for checking whether fields of view of the first and the second camera system overlap by comparing image data of the first and the second camera system. The method further can comprise adjusting, if the fields of view do not overlap, a pose of the first and/or the second camera system.

In scenarios where the fields of view do not overlap, it may not be possible to determine the geometric relation of the first and the second image data.

In particular, before the first and the second image data is recorded, one can check whether the fields of view of the first and the second camera system overlap and, if necessary, can adjust the pose of the first and/or the second camera system. In order to check whether the fields of view overlap, the image data of the first and the second camera system can be examined for similarities (e.g. features being present in the image data of the first and the second camera system).

In some embodiments, the method comprises receiving first scaled positional data of the first aerial vehicle and second scaled positional data of the second aerial vehicle using a satellite-based positioning system and/or a barometer-based positioning system and deriving a scaled absolute position of the first and the second aerial vehicle to each other based on the relative position, the first, and the second scaled positional data.

In some applications of the method, the relative position of the first and the second aerial vehicle is a “non-dimensional” or “unscaled” measure. The first and the second positional data can be used as reference data to scale the relative position, i.e. to map the relative position to an absolute scale, to derive the scaled absolute position of the aerial vehicles.

In some embodiments, the method is executed on the first or the second aerial vehicle.

For this, the first and/or the second aerial vehicle can be equipped with an apparatus configured to execute the above method. This enables stand-alone applications in aerial vehicles where the aerial vehicles, for example, do not communicate with an external data processing apparatus.

In some embodiments, the method is executed on an external server separate from the first and the second aerial vehicle.

The first and the second camera system, for example, communicate the first and the second image data to the external server. The external server thus can determine the relative position according to the above method using the first and the second image data.

This can make a data processing circuitry on board the first and the second aerial vehicle superfluous. For this reason, weight of the aerial vehicles can be saved by leaving out such a data processing circuitry.

According to a further aspect, the present disclosure relates to a computer program comprising instructions, which, when the computer program is executed by a processor, cause the processor to carry out the aforementioned method.

According to a further aspect, the present disclosure relates to an apparatus for determining a relative position of a first aerial vehicle and at least one second aerial vehicle to each other. The apparatus comprises at least one interface and a data processing circuitry. The (at least one) interface is configured to receive first image data from a first camera system attached to the first aerial vehicle and second image data from a second camera system attached to the second aerial vehicle and a data processing circuitry is configured to determine a geometric relation of the first and the second image data and determine the relative position using the geometric relation of the first and the second image data.

### BRIEF DESCRIPTION OF THE FIGURES

Some examples of apparatuses and/or methods will be described in the following by way of example only, and with reference to the accompanying figures, in which

FIG. 1 shows a flowchart schematically illustrating a method for an image-based localization of aerial vehicles;

FIG. 2 shows a block diagram schematically illustrating an apparatus providing an image-based localization of aerial vehicles;

FIGS. 3a and 3b illustrate a first application scenario of the method/apparatus; and

FIG. 4 illustrates a second application scenario of the method/apparatus.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an ‘or’, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In some navigation applications, a localization of aerial vehicles with sub-m-accuracy, i.e. an accuracy of less than one meter, is desired, for example, to avoid collisions between aerial vehicles operating in close proximity (e.g. less than one meter of each other). In some applications or circumstances (e.g. weather conditions), satellite- or barometer-based positioning systems cannot provide sub-m-accuracy. In particular, those positioning systems may not be able to provide sub-m-accuracy in vertical direction.

Hence, there is a demand for an improved concept for locating aerial vehicles.

A basic idea of the present disclosure is an image-based positioning concept using image data from cameras attached to encountering aerial vehicles to locate the aerial vehicles with sub-m-accuracy.

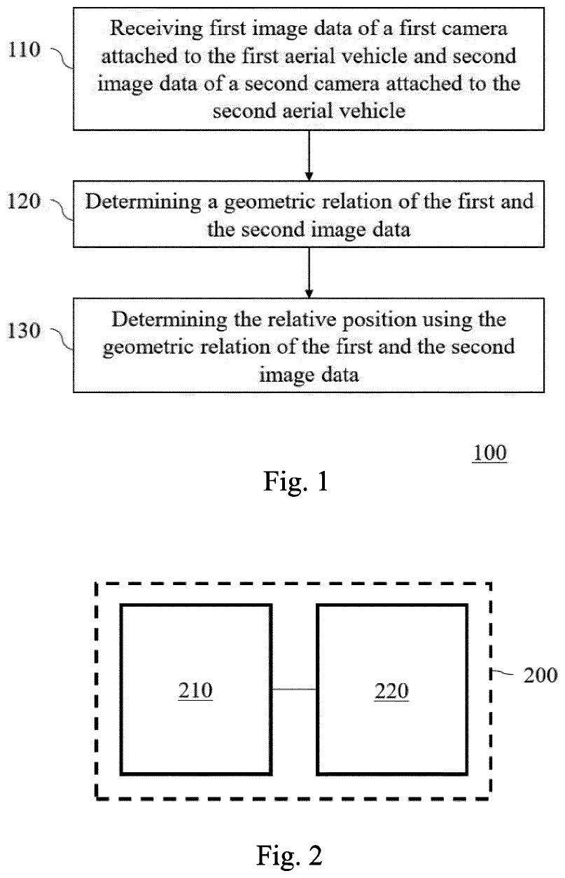

FIG. 1 shows a flowchart schematically illustrating a method 100 for an image-based localization of aerial vehicles.

Method 100 comprises receiving 110 first image data of a first camera system attached to the first aerial vehicle and second image data of a second camera system attached to the second aerial vehicle.

Further, method 100 comprises determining 120 a geometric relation of the first and the second image data and determining 130 the relative position using the geometric relation of the first and the second image data.

In practice, the first and the second camera system can be mounted to the first and the second aerial vehicle, such that their respective field of view points diagonally downwards in flight direction. Accordingly, when the first and the second aerial vehicle approach each other, the fields of view of the first and the second camera system may (at least partly) overlap with each other. Hence, the first and the second image data can include multiple features being present in the first and the second image data. Due to different perspectives of the camera systems, the features relate to different coordinates in a respective coordinate system of the first and the second image data. The respective coordinate system, for example, refers to a location of the first and the second camera system, respectively. A comparison of the coordinates can deliver the geometric relation between the coordinate systems and thus the relative position of the aerial vehicles.

Depending on a spatial resolution of the first and the second camera system, method 100 allows a localization of the first and the second aerial vehicles with sub-m-accuracy in vertical and horizontal direction.

In some applications, method 100 can be executed iteratively for tracking the relative position of aerial vehicles operating in close proximity (e.g. less than one meter of each other), encountering, and/or passing each other.

FIG. 2 shows a block diagram schematically illustrating an apparatus 200 providing an image-based localization of aerial vehicles. To this end, the apparatus 200 can execute method 100.

The apparatus 200 comprises an interface 210 and a data processing circuitry 220. The interface 210 is configured to receive first image data from a first camera system attached to the first aerial vehicle and second image data from a second camera system attached to the second aerial vehicle. The interface 210, for example, receives the first and/or the second image data via a radio signal or a wired connection to the first and the second camera system, respectively.

The interface 210 is coupled to the data processing circuitry 220 to provide the data processing circuitry 220 with the first and the second image data. The data processing circuitry 220 is configured to determine the geometric relation of the first and the second image data and determine the relative position using the geometric relation of the first and the second image data, as stated above with reference to method 100.

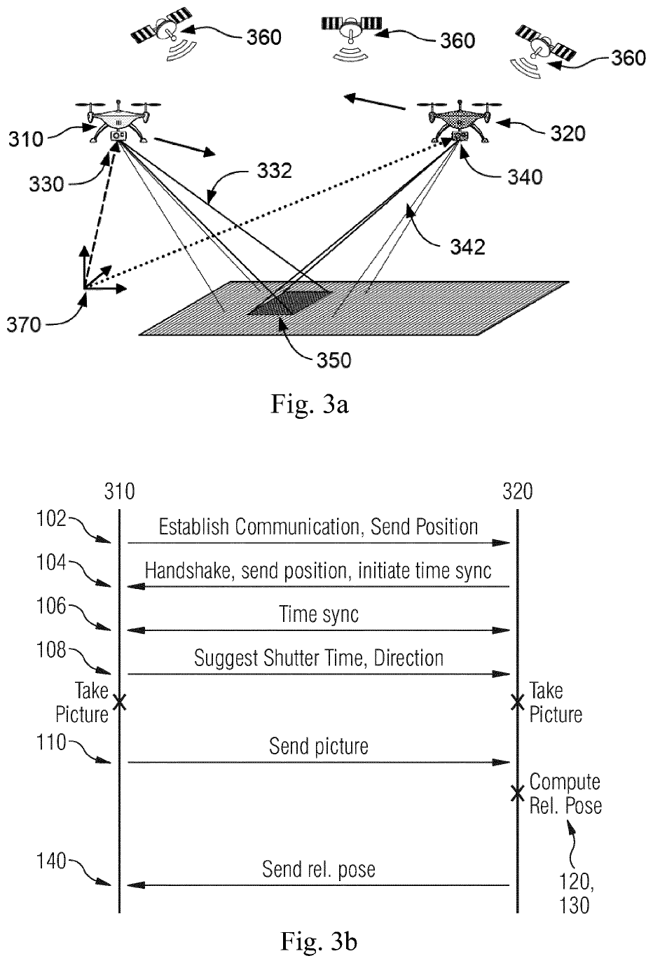

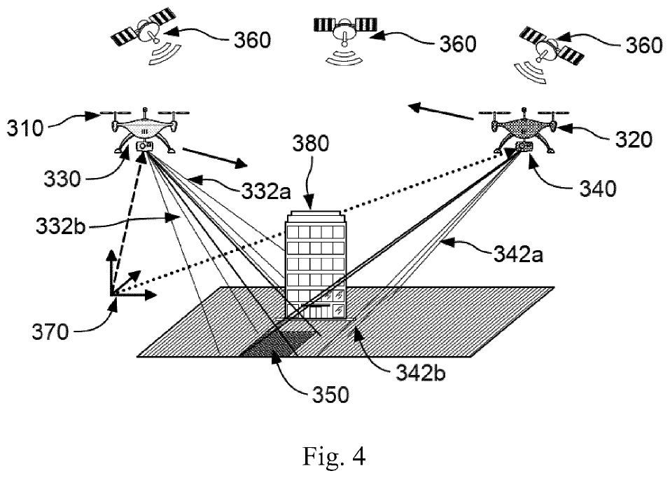

The apparatus 200 and method 100 should be described in more detail with reference to application scenarios of FIGS. 3a, 3b, and 4.

FIG. 3a and FIG. 3b illustrate a first application scenario where a first unmanned aerial vehicle (UAV) 310 and a second UAV 320 encounter each other The first and the second UAV 310 and 320 are equipped with a first camera system 330 and a second camera system 340, respectively.

In the application scenario of FIGS. 3a and 3b, both the first and the second UAV 310 and 320 are further equipped with a communication system (not shown). In a first step 102, UAV 310 can use its communication system to communicate its position to UAV 320. In a next step 104, UAV 320 can communicate its position to UAV 310. In this way, both UAV 310 and 320 can detect their mutually presence in a close proximity (e.g. in a range up to 50 m depending on a range of the communication system). The positions can be determined using respective barometer- or satellite-based positioning systems on board the UAV 310 and 320, respectively. The satellite-based positioning system of UAV 310 and 320, for example, communicates with multiple satellites 360 to measure the position of UAV 310 and 320, respectively.

As mentioned above, an accuracy of such positioning systems in vertical direction may not be accurate (e.g. less than one meter) enough to operate UAV 310 and 320 in a vertical distance of less than two meters from each other. Hence, method 100 can be applied for a more accurate localization than possible with the satellite- or barometer-based positioning system. For this, at least one of UAV 310 and 320 is equipped with the apparatus 200.

UAV 310 and UAV 320 are further equipped with a camera system 330 and 340, respectively, to record first and second image data of their environment.

For recording the first and the second image data synchronously, the camera systems 330 and 340, in step 106, synchronize with each other and communicate, in step 108, a shutter time to record the first and the second image data.

In practice, actual shutter times of UAV 310 and 320 may differ from each other and the communicated shutter time. Errors or uncertainties of the resulting relative position, which are induced by differences of the actual shutter times, can be compensated based on the UAVs' velocities determined using satellite-based (e.g. GNSS) or inertial sensors.

In step 108, the UAVs 310 and 320 communicate a direction where to steer the respective field of view 330/340 such that the fields of view 330 and 340 have an (maximal expected) overlap. The UAVs 310 and 320, can use their positions determined by the satellite-based positioning system to derive those directions.

In this application scenario, the camera systems 330 and 340, i.e. their respective field of view 332/342, point diagonally downwards such that their fields of view 332 and 342 partly overlap in an area 350. For reasons of simplicity, area 350 is assumed to be planar in the present application scenario.

Optionally, image data of the first and the second camera system can be compared to check whether their fields of view overlap and the camera systems can be adjusted or realigned if the fields of view do not overlap.

In step 109, the camera system 330 and 340 synchronously record first and second image data.

UAV 320 is equipped with the apparatus 200 comprising the interface 210 for receiving 110 the first and the second image data from the camera systems 330 and 340 and the data processing circuitry 220 for determining 120 the geometric relation of the first and the second image data and determining 130 the relative position using the geometric relation.

To this end, the data processing circuitry 220 can identify a plurality of features present in both the first and the second image data using computer vision. The features, for example, relate to multiple objects in area 350.

Further data processing of the data processing circuitry 220 includes determining 120 first coordinates of the features in the first image data and second coordinates of the features in the second image data and determining 130 the geometric relation between the first and the second image data using the first and the second coordinates. The data processing circuitry 220, for example, uses the first and the second coordinates as input to the eight-point algorithm providing the relative position of the UAVs 310 and 320 in a common coordinate system 370.

The skilled person having benefit from the present disclosure will appreciate that other approaches for determining the relative position using computer or machine learning can be used. E.g. other machine learning algorithms can be used for determining the relative position.

In step 140, the UAVs 310 and 320 communicate their relative position, for example, to initiate and coordinate an evasive maneuver, if necessary.

The relative position can be indicative of a “scale-free” relative altitude and relative horizontal position of the UAVs 310 and 320 to each other. In some applications, the relative altitude or horizontal position is sufficient to determine the evasive maneuver. The evasive maneuver, for example, provides for opposed movements of the UAVs 310 and 320 in vertical direction (e.g. UAV 310 rises by 20 cm and UAV 320 sinks by 20 cm).

Optionally, the apparatus 200 derives a “scaled” absolute position of the first and the second aerial vehicle to each other from the relative position using scaled positional data (e.g. longitude and latitude) of the UAVs 310 and 320 as reference data. The satellite-based positioning system, for example, provides the scaled positional data.

Depending on a spatial resolution of the first and the second image data, the above method 100 and apparatus 200 allow a more accurate localization of the UAVs 310 and 320 than satellite- or barometer-based positioning systems. In particular, method 100 and the apparatus 200 allow a more accurate localization of the UAVs 310 and 320 in vertical direction than satellite- or barometer-based positioning systems. In turn, this allows the operation of more UAVs in a given volume of airspace and the determination of more efficient trajectories of the UAVs.

FIG. 4 illustrates a second application scenario where fields of view 332a and 342a of the camera system 310 and 330 are blocked by a building 380 such that the fields of view 332a and 342a have no overlap. The data processing circuitry 220, for example, notices that the fields of view have no overlap by comparing image data of the camera system 330 and 340.

In such a scenario, the UAVs 310 and 320 can realign the camera system 330 and 340 (e.g. using actuators) such that their adjusted fields of view 332b and 342b overlap with each other in the area 350′. Subsequently, the apparatus 200 can determine their relative position in accordance with the above concept using the adjusted fields of view 332b and 342b.

Further embodiments pertain to:
(1) A method for determining a relative position of a first aerial vehicle and at least one second aerial vehicle to each other, the method comprising:
   receiving first image data of a first camera system attached to the first aerial vehicle and second image data of a second camera system attached to the second aerial vehicle;
   determining a geometric relation of the first and the second image data; and
   determining the relative position using the geometric relation of the first and the second image data.
(2) Method of (1), wherein determining the relative position comprises:
   identifying a plurality of features present in both the first and the second image data using computer vision;
   determining first coordinates of the features in the first image data and second coordinates of the features in the second image data; and
   determining the geometric relation of the first and the second image data using the first and the second coordinates.
(3) Method of (1) or (2), wherein the method comprises synchronizing the first and the second camera system for synchronously recording the first and the second image data.
(4) Method of any one of (1) to (3), wherein at least one of the first and the second aerial vehicle is an unmanned aerial vehicle.
(5) Method of any one of (1) to (4), the method comprising:
   checking whether fields of view of the first and the second camera system overlap by comparing image data of the first and the second camera system; and
   adjusting, if the fields of view do not overlap, a pose of the first and/or the second camera system.
(6) Method of any one of (1) to (5), wherein the relative position is indicative of a relative altitude of the first and the second aerial vehicle to each other.
(7) Method of any one of (1) to (6), wherein the method comprises:
   receiving first scaled positional data of the first aerial vehicle and second scaled positional data of the second aerial vehicle using a satellite based navigation system; and
   deriving a scaled absolute position of the first and the second aerial vehicle to each other based on the relative position, the first, and the second scaled positional data.
(8) Method of any one of (1) to (7), wherein the method is executed on the first or the second aerial vehicle.
(9) Method of any one of (1) to (7), wherein the method is executed on an external server separate from the first and the second aerial vehicle.
(10) A computer program comprising instructions, which, when the computer program is executed by a processor, cause the processor to carry out the method of any one of (1) to (9).
(11) An apparatus for determining a relative position of a first aerial vehicle and at least one second aerial vehicle to each other, the apparatus comprising:
   at least one interface configured to receive first image data from a first camera system attached to the first aerial vehicle and second image data from a second camera system attached to the second aerial vehicle; and
   a data processing circuitry configured to
      determine a geometric relation of the first and the second image data; and
      determine the relative position using the geometric relation of the first and the second image data.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A method for determining a relative position of a first aerial vehicle and at least one second aerial vehicle to each other, the method comprising:
receiving first image data of a first camera system attached to the first aerial vehicle and second image data of a second camera system attached to the second aerial vehicle;
determining a geometric relation of the first and the second image data; and
determining the relative position using the geometric relation of the first and the second image data.

2. Method of claim 1, wherein determining the relative position comprises:
identifying a plurality of features present in both the first and the second image data using computer vision;
determining first coordinates of the features in the first image data and second coordinates of the features in the second image data; and
determining the geometric relation of the first and the second image data using the first and the second coordinates.

3. Method of claim 1, wherein the method comprises synchronizing the first and the second camera system for synchronously recording the first and the second image data.

4. Method of claim 1, wherein at least one of the first and the second aerial vehicle is an unmanned aerial vehicle.

5. Method of claim 1, the method comprising:
checking whether fields of view of the first and the second camera system overlap by comparing image data of the first and the second camera system; and
adjusting, if the fields of view do not overlap, a pose of the first and/or the second camera system.

6. Method of claim 1, wherein the relative position is indicative of a relative altitude of the first and the second aerial vehicle to each other.

7. Method of claim 1, wherein the method comprises:
receiving first scaled positional data of the first aerial vehicle and second scaled positional data of the second aerial vehicle using a satellite based navigation system; and
deriving a scaled absolute position of the first and the second aerial vehicle to each other based on the relative position, the first, and the second scaled positional data.

8. Method of claim 1, wherein the method is executed on the first or the second aerial vehicle.

9. Method of claim 1, wherein the method is executed on an external server separate from the first and the second aerial vehicle.

10. A computer program comprising instructions, which, when the computer program is executed by a processor, cause the processor to carry out the method of claim 1.

11. An apparatus for determining a relative position of a first aerial vehicle and at least one second aerial vehicle to each other, the apparatus comprising:
at least one interface configured to receive first image data from a first camera system attached to the first aerial vehicle and second image data from a second camera system attached to the second aerial vehicle; and
a data processing circuitry configured to
determine a geometric relation of the first and the second image data; and
determine the relative position using the geometric relation of the first and the second image data.
